(19) United States
(12) Patent Application Publication
(10) Pub. No.: US 2002/0035519 A1
(43) Pub. Date: Mar. 21, 2002

(54) Music delivery system and method thereof

(76) Inventor: Hiroshi Takizawa, Tokyo (JP)

Correspondence Address: YOUNG & THOMPSON, 745 SOUTH 23RD STREET 2ND FLOOR, ARLINGTON, VA, 22202

(21) Appl. No.: 09/956,462

(22) Filed: Sep. 20, 2001

(30) Foreign Application Priority Data
Sep. 21, 2000 (JP) 2000-286922

(51) Int. Cl. G06F 17/60

(52) U.S. Cl. 705/26

(57) ABSTRACT

A music delivery system and a method of the system, in which a user, who connects to a server for music delivery by using a browser on a terminal, can easily find favorite music from a group of unknown or not well known music, at a music delivery service utilized a network such as the Internet, are provided. A user connects his/her terminal to a Web server in which a music delivery service is working, and chooses listening to music on trial on a Web browser screen displayed on a display of the terminal. The Web server transmits a group of salable music to the terminal by using a streaming technology in sequence one by one for a predetermined time. The user listens to the music transmitted from the Web server through a speaker in the terminal. When the user finds his/her favorite music, the user chooses the favorite music and purchases the favorite music on a screen displayed on the display of the terminal. The Web sever charges the user the amount of said favorite music.

### BACKGROUND OF THE INVENTION

The present invention relates to a music delivery system and a method thereof, which relate to a music delivery technology utilized a network such as the Internet, and in particular, in which a user, who connects to a server for music delivery by using a browser on a terminal, can easily find his/her favorite music from a group of unknown or not well known music.

### DESCRIPTION OF THE RELATED ART

Generally, when a user purchases a piece of music as a type of a compact disk (CD) or through a music delivery system, the user often chooses his/her favorite music from a group of music that the user listened in to on media such as a radio and a TV. And the user may purchase his/her favorite music after the user checked currently selling well music by referring to hit charts announced or published by the media.

However, music, which media such as a radio and a TV are broadcasting, is only a part of the music being especially sold well in the music being sold at the time when users checked the group of music. On the other hand, the users have different tastes in music and a piece of favorite music for the users is not always in the most selling well music. And their favorite music may be in the group of music not being sold well, however there is only a few chance that the users can listen to the music not being sold well. Therefore, there is a problem that it is not easy for the users to find their favorite music in the group of music not being sold well.

### SUMMARY OF THE INVENTION

It is therefore an object of the present invention to provide a music delivery system and a method thereof, in which a user, who connects to a server for music delivery by using a browser on a terminal, can easily find favorite music from a group of unknown or not well known music, at a music delivery service utilized a network such as the Internet.

According to a first aspect of the present invention for achieving the object mentioned above, there is provided a music delivery system. The music delivery system provides a Web server connecting to a network, and terminals connecting to each of the Web server through the network. And the Web server provides Web sites that execute a music delivery service, a means for executing a streaming broadcast of music through the Web sites, and a means for charging a user of each of the terminals an amount of money for music when an order for the music from the user is received through each of the Web sites. And each of the terminals provides a Web browser for accessing to each of the Web sites in the Web server, a means for receiving the streaming broadcast of music that is transmitted from the Web server, a display in which a Web browser screen of the music delivery system is displayed, and a speaker through which the user listens to the music transmitted from the Web server on trial. And when the terminal accessed to the Web server and the user of the terminal chose listening music on trial on the Web browser screen displayed on the display of the terminal, the Web server transmits some pieces of salable music to the terminal by using a streaming technology in sequence one by one for a predetermined time, and the user of the terminal listens to the music transmitted from the Web server on trial through the speaker, and when the user finds favorite music from some pieces of the salable music, the user chooses the favorite music on the Web browser screen displayed on the display and purchases the favorite music, and the Web server charges the user of the terminal the amount of the favorite music.

According to a second aspect of the present invention, in the first aspect, the music delivery system further provides a means for listening to the favorite music (previous music) on trial again through the speaker of the terminal, by that the user clicks a designated button displayed on the Web browser screen displayed on the display of the terminal by putting a mouse on the designated button, when music next to the favorite music is already streaming through the speaker of the terminal of the user.

According to a third aspect of the present invention, in the first aspect, the music delivery system further provides a means for watching information of the favorite music on a screen displayed on the display of the terminal by the user.

According to a fourth aspect of the present invention, in the first aspect, the music delivery system further provides a means for purchasing the favorite music by the user on a screen displayed on the display of the terminal in addition to watching information of the favorite music.

According to a fifth aspect of the present invention, there is provided a music delivery system. The music delivery system provides a Web server connecting to a network, and terminals connecting to the Web server through the network. And the Web server provides Web sites that execute a music delivery service, a means for executing a streaming broadcast of music through the Web sites, and a means for charging a user of each of the terminals an amount of money for music when an order for the music from the user is received through each of the Web sites. And each of the terminals provides a Web browser for accessing to the Web sites in the Web server, a means for receiving the streaming broadcast of music that is transmitted from the Web server, a display in which a Web browser screen having several buttons and columns and a region for the music delivery system is displayed, and a speaker through which the user listens to the music transmitted from the Web server on trial. And when the terminal accessed to the Web server and the user of the terminal chose listening music on trial on the Web browser screen displayed on the display of the terminal, the Web server transmits some pieces of salable music to the terminal by using a streaming technology in sequence one by one for a predetermined time, and the user of the terminal listens to the music transmitted from the Web server on trial through the speaker, and when the user finds favorite music from some pieces of the salable music, the user chooses the favorite music on the Web browser screen displayed on the display and purchases the favorite music, and the Web server charges the user of the terminal the amount of the favorite music.

According to a sixth aspect of the present invention, in the fifth aspect, a “listening start” button, with which the user starts listening to music on trial, is provided on the Web browser screen displayed on the display.

According to a seventh aspect of the present invention, in the fifth aspect, a “previous music” button, with which the user listens to music being previous to music streaming at present on trial, is provided on the Web browser screen displayed on the display.

According to an eighth aspect of the present invention, in the fifth aspect, an “information display” button, with which the user changes the Web browser screen to a screen in which the information of listening music on trial is displayed and a screen purchasing the music, is provided on the Web browser screen displayed on the display.

According to a ninth aspect of the present invention, in the fifth aspect, a “listening stop” button, with which the user stops listening music on trial in the middle of listening, is provided on the Web browser screen displayed on the display.

According to a tenth aspect of the present invention, in the fifth aspect, a “next music” button, with which the user listens to the next music on trial by stopping listening to music streaming at present, is provided on the Web browser screen displayed on the display.

According to an eleventh aspect of the present invention, in the fifth aspect, a “repeat listening” button, with which the user listens to the music streaming at present on trial repeatedly, is provided on the Web browser screen displayed on the display.

According to a twelfth aspect of the present invention, in the fifth aspect, a “listening time setting” column, with which the user sets listening time of a piece of music, is provided on the Web browser screen on the display.

According to a thirteenth aspect of the present invention, in the fifth aspect, a “genre selection” column, with which the user selects a genre of music that the user wants to listen to, is provided on the Web browser screen displayed on the display.

According to a fourteenth aspect of the present invention, in the fifth aspect, a “music information” region, in which the name of singer(s) and band and/or the name of music streaming at present are displayed, is provided on the Web browser screen displayed on the display of the terminal.

According to a fifteenth aspect of the present invention, a music delivery method in a music delivery system provides the steps of, connecting a terminal of a user to a Web server in which a music delivery system is working through a network, displaying a Web browser screen on a display of the terminal, choosing listening music on trial on the Web browser screen displayed on the display of the terminal by the user, transmitting some pieces of salable music to the terminal by using a streaming technology in sequence one by one for a predetermined time from the Web server, listening to the music transmitted from the Web server on trial through a speaker of the terminal by the user, choosing favorite music on the Web browser screen displayed on the display by the user when the user of the terminal finds the favorite music from some pieces of the salable music, purchasing the favorite music by the user, and charging the user of the terminal the amount of the favorite music from the Web server.

According to a sixteenth aspect of the present invention, there is provided a music delivery method in a music delivery system, in which a Web server connecting to a network and terminals connecting to the Web server through the network are provided. The music delivery method provides the steps of, executing a music delivery service by Web sites in the Web server, executing a streaming broadcast of music through each of the Web sites to the terminals, accessing from the terminal to each of the Web sites in the Web server through the network by using a Web browser in the terminal, receiving the streaming broadcast of music that is transmitted from the Web server at the terminal, displaying a Web browser screen of the music delivery system on a display of the terminal, listening to the music transmitted from the Web server on trial by using the Web browser screen by a user at the terminal, choosing favorite music on the Web browser screen displayed on the display by the user when the user of the terminal finds the favorite music from some pieces of the salable music from the Web server, purchasing the favorite music by the user, and charging the user of the terminal the amount of the favorite music from the Web server.

According to a seventeenth aspect of the present invention, in the sixteenth aspect, the music delivery method further provides the step of; listening to the favorite music (previous music) on trial again through the speaker of the terminal by the user, by that the user clicks a designated button displayed on the Web browser screen displayed on the display of the terminal by putting a mouse on the designated button, when music next to the favorite music is already streaming through the speaker of the terminal of the user.

According to an eighteenth aspect of the present invention, in the sixteenth aspect, the music delivery method further provides the step of; watching information of the favorite music on a screen displayed on the display of the terminal by the user.

According to a nineteenth aspect of the present invention, in the sixteenth aspect, the music delivery method further provides the step of; purchasing the favorite music by the user on a screen displayed on the display of the terminal, in addition to watching information of the favorite music.

According to a twentieth aspect of the present invention, in the sixteenth aspect, the music delivery method further provides the steps of; after the user connected the terminal to the Web server through the network, starting listening to music transmitting from the Web server by clicking a “listening start” button displayed on the Web browser screen displayed on the display of the terminal by the user, listening to music being previous to music streaming at present by clicking a “previous music” button displayed on the Web browser screen displayed on the display of the terminal by the user, when the user wants to listen to the previous music again, and changing the Web browser screen to a screen in which the information of listening music on trial is displayed and a screen for purchasing the music, by clicking an “information display” button displayed on the Web browser screen displayed on the display of the terminal by the user, when the user wants to obtain the information of the music and purchase the music.

According to a twenty-first aspect of the present invention, in the sixteenth aspect, the music delivery method further provides the steps of; after the user connected the terminal to the Web server through the network, starting listening to music transmitting from the Web server by clicking a “listening start” button displayed on the Web browser screen displayed on the display of the terminal by the user, listening to music being previous to music streaming at present by clicking a “previous music” button displayed on the Web browser screen displayed on the display of the terminal by the user, when the user wants to listen to the previous music again, changing the Web browser screen to a screen in which the information of listening music on trial is displayed and a screen for purchasing the music, by clicking an “information display” button displayed on the Web browser screen displayed on the display of the terminal by the user, when the user wants to obtain the information of the music and purchase the music, stopping listening music on trial in the middle of listening to the music by clicking a “listening stop” button displayed on the Web browser screen displayed on the display of the terminal by the user, when the user wants to stop listening the music in the middle of listening on trial, listening to the next music on trial by stopping listening to music streaming at present by clicking a “next music” button displayed on the Web browser screen displayed on the display of the terminal by the user, when the user wants to stop listening the music streaming at present and to listen to the next music, listening to the music streaming at present on trial repeatedly by clicking a “repeat listening” button displayed on the Web browser screen displayed on the display of the terminal by the user, when the user wants to listen to the music streaming at present repeatedly, setting listening time of a piece of music by inputting listening time of one piece of music to a “listening time setting” column displayed on the Web browser screen displayed on the display of the terminal by the user, selecting a genre of music by clicking a “genre selection” column displayed on the Web browser screen displayed on the display of the terminal by the user, when the user wants to listen to music by specifying the genre of music, and obtaining information of the name of singer(s) and band and/or the name of the music streaming at present from a “music information” region displayed on the Web browser screen displayed on the display of the terminal by the user.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of a music delivery system at an embodiment of the present invention;

FIG. 2 is a diagram showing a first displaying example on a Web browser screen displayed on a display of a terminal connected to a Web server in the music delivery system shown in FIG. 1 at the embodiment of the present invention; and

FIG. 3 is a diagram showing a second displaying example on the Web browser screen displayed on the display of the terminal connected to the Web server in the music delivery system shown in FIG. 1 at the embodiment of the present invention.

### DESCRIPTION OF THE PREFERRED EMBODIMENTS

Referring now to the drawings, an embodiment of the present invention is explained in detail. At a music delivery system and a method of the system of the present invention, a user, who connects to a server for music delivery by using a browser on a terminal such as a personal computer (PC) and a Web terminal, can easily find his/her favorite music from a group of unknown or not well known music, in a music delivery service utilized a network such as the Internet.

At the music delivery system of the present invention, a user connects a terminal (PC or Web terminal) to a Web server in which a music delivery system is working. And when the user chooses to listen to music on trial on a Web browser screen displayed on a display of the terminal of the user, the Web server transmits each of pieces of salable music to the terminal of the user for a predetermined time in sequence one by one by using a streaming technology. The user can listen to each of the pieces of music transmitted from the Web server through a speaker of the terminal of the user. At the case that favorite music for the user exists, the user chooses the favorite music on the Web browser screen displayed on the display of the terminal of the user, and then the user can purchase the favorite music.

Even when music next to the favorite music is already streaming from the speaker of the terminal of the user, the user can listen to the favorite music on trial again through the speaker of the terminal of the user by that the user clicks a button on the Web browser screen displayed on the display by using a mouse. And also the user can watch information of the music that the user is listening to, and can purchase the music.

As the Web server in which the music delivery system is working, a general Web server can be used. And as a terminal connecting to the Web server, a terminal such as a PC and a Web terminal, on which a Web browser can work, can be used, and the terminal is connected to the Web server through a network such as the Internet.

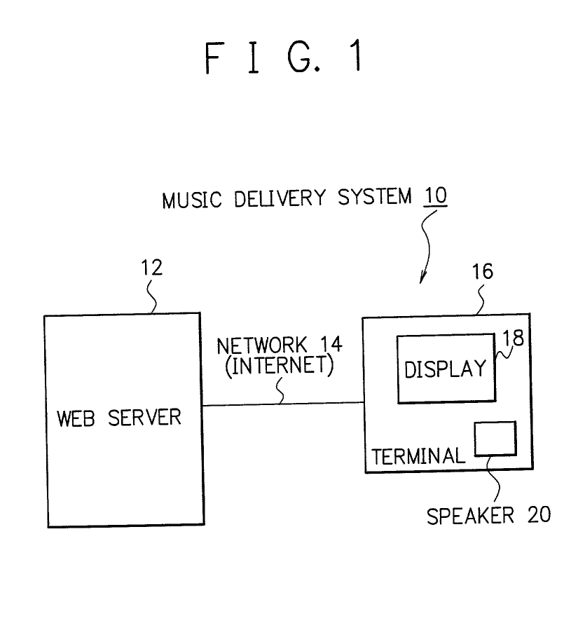

Next, referring to the drawings, the embodiment of the present invention is explained in detail. FIG. 1 is a block diagram showing a structure of the music delivery system at the embodiment of the present invention. As shown in FIG. 1, at a music delivery system 10, a terminal 16 (PC or Web terminal) is connected to a Web server 12 through a network 14 such as the Internet, and the terminal 16 provides a display 18 and a speaker 20. In this, plural terminals 16 are actually connected to the Web server 12 through the network 14, however, in order to make the explanation concise, at this explanation, the number of the terminals 16 is made to be one. And in a case, plural Web servers 12 are provided in the music delivery system 10, however, in this explanation one Web server 12 is used.

The Web server 12 has a main function that executes a music delivery method (operating programs) in the music delivery system 10 at the embodiment of the music delivery system of the present invention. And the Web server 12 provides a means for executing streaming broadcast of music and a means for charging a user the amount of money for delivering music when the Web server 12 receives an order for the music from the user, in addition to several means for executing functions of the general Web server for Web sites.

The terminal 16 provides a Web browser for accessing to each of Web sites in the Web server 12, the display 18 that displays a Web browser screen, and the speaker 20 through which the user listens to music on trial transmitted from the Web server 12.

And in the Web browser in the terminal 16 for accessing to each of the Web sites in the Web server 12, a means for receiving the streaming broadcast of music from the Web server 12, which needs at the music delivery method (operating programs) in the music delivery system 10, is provided.

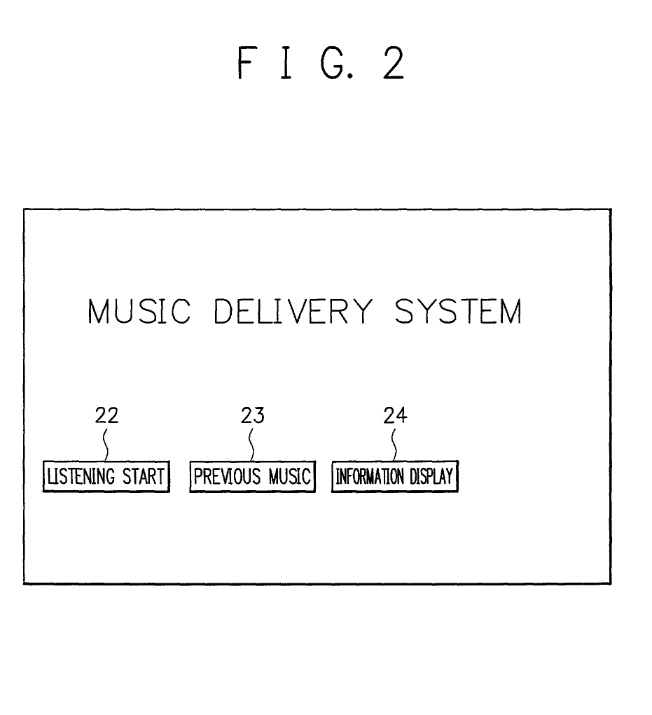

FIG. 2 is a diagram showing a first displaying example on the Web browser screen displayed on the display 18 of the terminal 16 connected to the Web server 12 in the music delivery system 10 shown in FIG. 1 at the embodiment of the present invention, As shown in FIG. 2, the first displaying example shows MUSIC DELIVERY SYSTEM, a “listening start” button 22, a “previous music” button 23, and an “information display” button 24.

As shown in FIG. 2, when the terminal 16 is connected to the Web server 12 through the network 14, on the Web browser screen displayed on the display 18 of the terminal 16, MUSIC DELIVERY SYSTEM, the “listening start” button 22 with which the user starts to listen to music on trial, the “previous music” button 23 with which the user listens to the previous music on trial, and the “information display” button 24 with which the user makes the screen change to a screen in which the information of the listening music is displayed and to a screen with which the user purchases the music, are displayed.

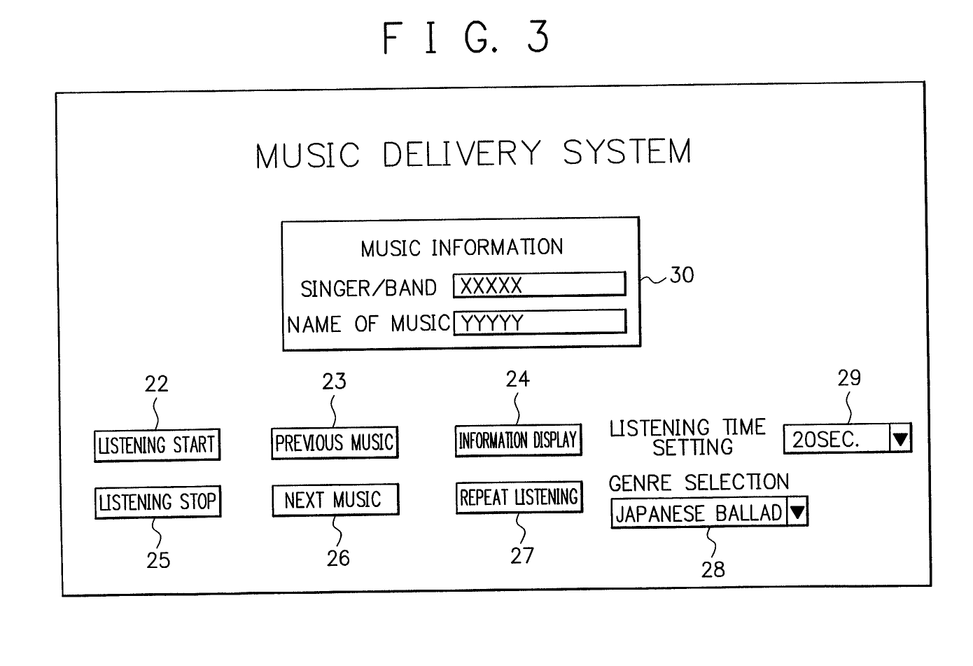

FIG. 3 is a diagram showing a second displaying example on the Web browser screen displayed on the display 18 of the terminal 16 connected to the Web server 12 in the music delivery system 10 shown in FIG. 1 at the embodiment of the present invention. As shown in FIG. 3, the second displaying example shows a “listening stop” button 25, a “next music” button 26, a “repeat listening” button 27, a “genre selection” column 28, a “listening time setting” column 29, and a “music information” region 30, in addition to the buttons 22, 23, and 24 and MUSIC DELIVERY SYSTEM shown in the first displaying example shown in FIG. 2.

As shown in FIG. 3, when the terminal 16 is connected to the Web server 12 through the network 14, on the Web browser screen displayed on the display 18 of the terminal 16, the following buttons, columns and a region are displayed, in addition to the buttons 22, 23, and 24, and the MUSIC DELIVERY SYSTEM shown in FIG. 2. In FIG. 3, the buttons are the “listening stop” button 25 with which the user stops listening music in the middle of the listening on trial, the “next music” button 26 with which the user listens to the next music, the “repeat listening” button 27 with which the user listen to the same music repeatedly. And the columns are the “genre selection” column 28 with which the user selects a genre of music that the user wants to listen to on trial (in FIG. 3, Japanese ballad), the “listening time setting” column 29 with which the user sets the listening time on trial for a piece of music (in FIG. 3, 20 seconds). And the region is the “music information” region 30 on which the music information such as the name of singer(s)/band and the name of music that the user is listening to is displayed.

Next, the music delivery method of the present invention is explained in detail. That is, the operation of the music delivery system 10 of the present invention is explained. First, referring to FIGS. 1 and 2, by using the first displaying example, the music delivery method of the present invention is explained. When a user connects the terminal 16 to the Web server 12 through the network 14, a Web browser screen is displayed on the display 18 of the terminal 16. And when the user clicks the “listening start” button 22 by putting the mouse on the button, each of many pieces of music registered in each of the Web sites in the Web server 12 is broadcast by the streaming broadcast for a predetermined time, for example, 20 seconds, in sequence one by one.

When the user finds a piece of music being favorite for the user by the sound from the speaker 20, the user clicks the “information display” button 24 by putting the mouse on the button. Then the Web browser screen is changed to a screen in which the information of the favorite music and a music purchasing screen are displayed.

And at the time when next music is already broadcasting but the user wants to display the information of the favorite music after listening to the favorite music from the speaker 20, the user clicks the “previous music” button 23 by putting the mouse on the button. With this, the user can listen to the favorite music again and can change the Web browser screen to the screen of the information of the favorite music and the music purchasing screen.

Next, referring to FIGS. 1 and 3, by using the second displaying example, the music delivery method of the present invention is explained. When a user connects the terminal 16 to the Web server 12 through the network 14, a Web browser screen is displayed on the display 18 of the terminal 16. In addition to the operation mentioned above at the first displaying example, the following operation can be executed at the second displaying example.

When the user wants to stop listening to music on trial, the user clicks the “listening stop” button 25 by putting the mouse on the button. And also the user can change music broadcasting through the streaming broadcast before predetermined listening time for a piece of music passes, by clicking the “next music” button 26 by putting the mouse on the button.

And when the user wants to change the listening time for a piece of music, the user can change the listening time by using the “listening time setting” column 29. And further, when the user wants to listen to the music broadcasting at present repeatedly through the speaker 20, the user clicks the “repeat listening” button 27, then the user can listen to the music repeatedly by extending the predetermined listening time.

And when the user wants to select a genre of music desiring to listen to, the user selects the genre of music by using the “genre selection” column 28.

And further, the information of the music that the user is listening to at present can be displayed on the “music information” region 30 on the Web browser screen on the display 18 of the terminal 16. The information of music is the name of singer(s) and/or band, and the name of music, and so on.

As mentioned above, according to the embodiment of the present invention, at the music delivery service, the user, who connects his/her terminal 16 to the Web server 12 through the network 14 such as the Internet by using a browser, can easily find music being favorite for the user from a group of the unknown or not well known music.

That is, the user connects his/her terminal 16 to the Web server 12 in which the music delivery system 10 is working through the network 14 such as the Internet. And when the user executes to listen to music on trial on the Web browser screen on the display 18 of the terminal 16, a series of salable music is transmitted from the Web server 12 to the terminal 16 for a predetermined time in sequence one by one by using the streaming technology. The user can listen to the music transmitted from the Web server 12 through the speaker 20 of the terminal 16. When the user finds a piece of favorite music, the user can purchase the favorite music by choosing the favorite music on the Web browser screen on the display 18.

Even when music next to the favorite music for the user is already broadcasting through the speaker 20 of the terminal 16, the user can listen to the favorite music again through the speaker 20 by that the user clicks a designated button on the Web browser screen on the display 18 by using the mouse. Further, the user can watch the information of the favorite music and also can purchase the music.

As mentioned above, according to the present invention, a user can easily find his/her favorite music in a group of unknown or not well known music, and can purchase the favorite music. In addition to this, for musicians and singers and bands, who are not known well, their fans can be expanded and the sales amount for the music can be increased.

And further, according to the present invention, while the user is listening to music on trial through a speaker of a terminal of the user, the terminal remains connecting to a Web server in which the music delivery system is working. Therefore, the terminal of the user stays in the music delivery system for a long time and also the user always watches the Web browser screen in order that the user can immediately click a “information display” button when his/her favorite music is broadcast. Consequently, it is expected that the Web browser screen is continuously displayed at the most watch-able front position on the display of the terminal. Therefore, when an advertisement is displayed on the Web browser screen, the charge for the advertisement can be set in a high price, and the income from the advertisement can be expected.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A music delivery system, comprising:
a Web server connecting to a network; and
terminals connecting to said Web server through said network, wherein:
said Web server, comprising:
Web sites that execute a music delivery service;
a means for executing a streaming broadcast of music through said Web sites; and
a means for charging a user of each of said terminals an amount of money for music when an order for said music from said user is received through each of said Web sites, and
each of said terminals, comprising:
a Web browser for accessing to each of said Web sites in said Web server;
a means for receiving said streaming broadcast of music that is transmitted from said Web server;
a display in which a Web browser screen of said music delivery system is displayed; and
a speaker through which said user listens to said music transmitted from said Web server on trial, wherein:
when said terminal accessed to said Web server and said user of said terminal chose listening music on trial on said Web browser screen displayed on said display of said terminal, said Web server transmits some pieces of salable music to said terminal by using a streaming technology in sequence one by one for a predetermined time, and said user of said terminal listens to said music transmitted from said Web server on trial through said speaker, and when said user finds favorite music from some pieces of said salable music, said user chooses said favorite music on said Web browser screen displayed on said display and purchases said favorite music, and said Web server charges said user of said terminal the amount of said favorite music.

2. A music delivery system in accordance with claim 1, further comprising:
a means for listening to said favorite music (previous music) on trial again through said speaker of said terminal, by that said user clicks a designated button displayed on said Web browser screen displayed on said display of said terminal by putting a mouse on said designated button, when music next to said favorite music is already streaming through said speaker of said terminal of said user.

3. A music delivery system in accordance with claim 1, further comprising:
a means for watching information of said favorite music on a screen displayed on said display of said terminal by said user.

4. A music delivery system in accordance with claim 1, further comprising:
a means for purchasing said favorite music by said user on a screen displayed on said display of said terminal in addition to watching information of said favorite music.

5. A music delivery system, comprising:
a Web server connecting to a network; and
terminals connecting to said Web server through said network, wherein:
said Web server, comprising:
Web sites that execute a music delivery service;
a means for executing a streaming broadcast of music through said Web sites; and
a means for charging a user of each of said terminals an amount of money for music when an order for said music from said user is received through each of said Web sites, and
each of said terminals, comprising:
a Web browser for accessing to said Web sites in said Web server;
a means for receiving said streaming broadcast of music that is transmitted from said Web server;
a display in which a Web browser screen having several buttons and columns and a region for said music delivery system is displayed; and
a speaker through which said user listens to said music transmitted from said Web server on trial, wherein:
when said terminal accessed to said Web server and said user of said terminal chose listening music on trial on said Web browser screen displayed on said display of said terminal, said Web server transmits some pieces of salable music to said terminal by using a streaming technology in sequence one by one for a predetermined time, and said user of said terminal listens to said music transmitted from said Web server on trial through said speaker, and when said user finds favorite music from some pieces of said salable music, said user chooses said favorite music on said Web browser screen displayed on said display and purchases said favorite music, and said Web server charges said user of said terminal the amount of said favorite music.

6. A music delivery system in accordance with claim 5, wherein:
a “listening start” button, with which said user starts listening to music on trial, is provided on said Web browser screen displayed on said display.

7. A music delivery system in accordance with claim 5, wherein:
a “previous music” button, with which said user listens to music being previous to music streaming at present on trial, is provided on said Web browser screen displayed on said display.

8. A music delivery system in accordance with claim 5, wherein:
an “information display” button, with which said user changes said Web browser screen to a screen in which the information of listening music on trial is displayed and a screen purchasing said music, is provided on said Web browser screen displayed on said display.

9. A music delivery system in accordance with claim 5, wherein:
a “listening stop” button, with which said user stops listening music on trial in the middle of listening, is provided on said Web browser screen displayed on said display.

10. A music delivery system in accordance with claim 5, wherein:
a “next music” button, with which said user listens to the next music on trial by stopping listening to music streaming at present, is provided on said Web browser screen displayed on said display.

11. A music delivery system in accordance with claim 5, wherein:
a “repeat listening” button, with which said user listens to the music streaming at present on trial repeatedly, is provided on said Web browser screen displayed on said display.

12. A music delivery system in accordance with claim 5, wherein:
a “listening time setting” column, with which said user sets listening time of a piece of music, is provided on said Web browser screen on said display.

13. A music delivery system in accordance with claim 5, wherein:
a “genre selection” column, with which said user selects a genre of music that said user wants to listen to, is provided on said Web browser screen displayed on said display.

14. A music delivery system in accordance with claim 5, wherein:
a “music information” region, in which the name of singer(s) and band and/or the name of music streaming at present are displayed, is provided on said Web browser screen displayed on said display of said terminal.

15. A music delivery method in a music delivery system, comprising the steps of:
connecting a terminal of a user to a Web server in which a music delivery system is working through a network;
displaying a Web browser screen on a display of said terminal;
choosing listening music on trial on said Web browser screen displayed on said display of said terminal by said user;
transmitting some pieces of salable music to said terminal by using a streaming technology in sequence one by one for a predetermined time from said Web server;
listening to said music transmitted from said Web server on trial through a speaker of said terminal by said user;
choosing favorite music on said Web browser screen displayed on said display by said user when said user of said terminal finds said favorite music from some pieces of said salable music;
purchasing said favorite music by said user; and
charging said user of said terminal the amount of said favorite music from said Web server.

16. A music delivery method in a music delivery system, in which a Web server connecting to a network and terminals connecting to said Web server through said network are provided, comprising the steps of;
executing a music delivery service by Web sites in said Web server;
executing a streaming broadcast of music through each of said Web sites to said terminals;
accessing from said terminal to each of said Web sites in said Web server through said network by using a Web browser in said terminal;
receiving said streaming broadcast of music that is transmitted from said Web server at said terminal;
displaying a Web browser screen of said music delivery system on a display of said terminal;
listening to said music transmitted from said Web server on trial by using said Web browser screen by a user at said terminal;
choosing favorite music on said Web browser screen displayed on said display by said user when said user of said terminal finds said favorite music from some pieces of said salable music from said Web server;
purchasing said favorite music by said user; and
charging said user of said terminal the amount of said favorite music from said Web server.

17. A music delivery method in a music delivery system in accordance with claim 16, further comprising the step of:
listening to said favorite music (previous music) on trial again through said speaker of said terminal by said user, by that said user clicks a designated button displayed on said Web browser screen displayed on said display of said terminal by putting a mouse on said designated button, when music next to said favorite music is already streaming through said speaker of said terminal of said user.

18. A music delivery method in a music delivery system in accordance with claim 16, further comprising the step of:
watching information of said favorite music on a screen displayed on said display of said terminal by said user.

19. A music delivery method in a music delivery system in accordance with claim 16, further comprising the step of:
purchasing said favorite music by said user on a screen displayed on said display of said terminal, in addition to watching information of said favorite music.

20. A music delivery method in a music delivery system in accordance with claim 16, further comprising the steps of:
after said user connected said terminal to said Web server through said network,
starting listening to music transmitting from said Web server by clicking a “listening start” button displayed on said Web browser screen displayed on said display of said terminal by said user;
listening to music being previous to music streaming at present by clicking a “previous music” button displayed on said Web browser screen displayed on said display of said terminal by said user, when said user wants to listen to said previous music again; and
changing said Web browser screen to a screen in which the information of listening music on trial is displayed and a screen for purchasing said music, by clicking an “information display” button displayed on said Web browser screen displayed on said display of said terminal by said user, when said user wants to obtain said information of said music and purchase said music.

21. A music delivery method in a music delivery system in accordance with claim 16, further comprising the steps of
after said user connected said terminal to said Web server through said network,
starting listening to music transmitting from said Web server by clicking a “listening start” button displayed on said Web browser screen displayed on said display of said terminal by said user;
listening to music being previous to music streaming at present by clicking a “previous music” button displayed on said Web browser screen displayed on said display of said terminal by said user, when said user wants to listen to said previous music again;
changing said Web browser screen to a screen in which the information of listening music on trial is displayed and a screen for purchasing said music, by clicking an “information display” button displayed on said Web browser screen displayed on said display of said terminal by said user, when said user wants to obtain said information of said music and purchase said music;
stopping listening music on trial in the middle of listening to said music by clicking a “listening stop” button displayed on said Web browser screen displayed on said display of said terminal by said user, when said user wants to stop listening said music in the middle of listening on trial;
listening to the next music on trial by stopping listening to music streaming at present by clicking a “next music” button displayed on said Web browser screen displayed on said display of said terminal by said user, when said user wants to stop listening said music streaming at present and to listen to the next music;
listening to the music streaming at present on trial repeatedly by clicking a “repeat listening” button displayed on said Web browser screen displayed on said display of said terminal by said user, when said user wants to listen to said music streaming at present repeatedly;
setting listening time of a piece of music by inputting listening time of one piece of music to a “listening time setting” column displayed on said Web browser screen displayed on said display of said terminal by said user;
selecting a genre of music by clicking a “genre selection” column displayed on said Web browser screen displayed on said display of said terminal by said user, when said user wants to listen to music by specifying the genre of music; and
obtaining information of the name of singer(s) and band and/or the name of the music streaming at present from a “music information” region displayed on said Web browser screen displayed on said display of said terminal by said user.
